(19) United States
(12) Patent Application Publication
(10) Pub. No.: US 2018/0004869 A1
(43) Pub. Date: Jan. 4, 2018

(54) OUTPUT DEVICE, DATA STRUCTURE, OUTPUT METHOD, AND OUTPUT PROGRAM

(71) Applicant: NEC CORPORATION, Tokyo (JP)

(72) Inventors: Masato ASAHARA, Tokyo (JP); Takeshi YOSHIMURA, Tokyo (JP)

(73) Assignee: NEC CORPORATION, Tokyo (JP)

(21) Appl. No.: 15/544,732

(22) PCT Filed: Dec. 21, 2015
(86) PCT No.: PCT/JP2015/006361

§ 371 Date: Jul. 19, 2017

(30) Foreign Application Priority Data
Jan. 22, 2015 (JP) 2015-010492

(51) Int. Cl. G06F 17/50; G06F 11/34; G06F 9/50

(52) U.S. Cl. CPC G06F 17/5009; G06F 9/5083; G06F 11/3447

(57) ABSTRACT

An output device 10 is provided with an output unit 11 for outputting, on the basis of job feature information indicating the features of the job of a distributed processing system, estimation model application information that is information in a format suitable for an estimation model that estimates the amount of computer resources required for processing a task constituting the job. The estimation model application information may include word-containing information having binary information that indicates whether or not a character string indicated by the character string information included in the job feature information includes a prescribed word. The estimation model application information may include numerical inversion label information having, as string label information, a value derived by converting, by a prescribed function, the numeric value indicated by the numerical information included in the job feature information.

### TECHNICAL FIELD

The present invention relates to an output device, a data structure, an output method, and an output program, and particularly relates to an output device, data structure, output method, and output program used in performance prediction of a distributed processing system using a machine learning technique.

### BACKGROUND ART

A distributed processing system divides a given process (job) into one or more processes, and executes the processes (tasks) by a plurality of computers in parallel to reduce processing time.

To efficiently execute the job using the distributed processing system, the user needs to appropriately control the execution order of the tasks and assign computer resources, according to the features of the tasks.

For example, it is known that the processing time of the whole job is shortened by starting execution from a task having a long processing time. The user needs to recognize the processing time of each task beforehand, in order to achieve such execution order control that starts execution from a task having a long processing time.

For example, it is also known that the number of tasks executed in parallel is maximized by assigning minimum required the amount of computer resources upon task execution. The user needs to recognize the amount of computer resources required for task processing beforehand, in order to achieve the assignment of minimum required the amount of computer resources.

To recognize the features of the tasks such as processing time and the amount of computer resources beforehand, a method of estimating the features of the tasks using a machine learning technique is available. With this estimation method, for example, the user inputs observation information indicating the behavior of a task to a program including a machine learning algorithm, and executes the program.

By executing the program, the user obtains a mathematical model indicating the feature of the task as an output result. Feeding, into the obtained mathematical model, observation information of a task whose feature has not been recognized yet enables the user to obtain estimation information of the feature of the task.

Patent Literatures (PTLs) 1 to 3 and Non Patent Literatures (NPLs) 1 to 2 describe techniques relating to the estimation of the amount of computer resources required for task processing.

PTL 1 describes a technique of estimating the relationship between the resource usage and the load value from a log of the amount of resources used in previously executed tasks.

PTL2 describes a system for estimating the load characteristics of a program.

PTL3 describes a virtual machine arrangement structure control device including a prediction unit for predicting the peak usage of physical resources per time interval.

NPL 1 describes a technique of deriving the basis function of the amount of resource changes from change information of the amount of resources used by a virtual machine through the use of a wavelet transform, and estimating future the amount of resources demand using the derived basis function.

NPL 2 describes a technique of estimating the amount of resources necessary to satisfy a service level objective (SLO) from past task execution history and a result of executing a short duration test for a task scheduled for assignment, using collaborative filtering.

PTL4 describes an enterprise web mining system for generating online prediction and recommendation.

PTLs 5 to 6 each describe a technique relating to the conversion of information used for processing.

PTL5 describes a printer for assisting in settings upon print output to improve user convenience. The printer described in PTL5 divides, in the case where a print feature value is character information, the character information, and handles each character after the division as an independent print feature value.

PTL6 describes a computer system for performing task assignment in consideration of not only the load information of each individual computer but also the task being executed in each individual computer, the degree of association between the assigned task and another task, and the distance of the computer in a network. The computer system described in PTL6 uses a method of converting the amount of communication data of 100 kilobytes into 1, a method of assigning a value for each band, or a method of numerically converting a packet collision rate.

### CITATION LIST

### Patent Literature

PTL1: Japanese Patent No. 5354138

PTL2: International Patent Application Publication No. 2011/071010

PTL3: Japanese Patent Application Laid-Open No. 2012-159928

PTL4: Japanese Patent No. 5620933

PTL5: Japanese Patent Application Laid-Open No. 2012-022516

PTL6: Japanese Patent Application Laid-Open No. 2005-310120

### Non Patent Literature

NPL 1: Hiep Nguyen, Zhiming Shen, Xiaohui Gu, Sethuraman Subbiah, John Wilkes. “AGILE: elastic distributed resource scaling for Infrastructure-as-a-Service.” In Proc. of the 10th International Conference on Autonomic Computing (ICAC '13), pp. 69-82, 2013.

NPL 2: Christina Delimitrou and Christos Kozyrakis. “Quasar: Resource-Efficient and QoS-Aware Cluster Management.” In Proc. of the 19th International Conference on Architectural Support for Programming Languages and Operating Systems (ASPLOS '14), pp. 127-144, 2014.

### SUMMARY OF INVENTION

### Technical Problem

To accurately estimate the amount of computer resources required for task processing in the distributed processing system, data indicating the operation of the distributed processing system and task observation data need to be converted into data in a format suitable for the estimation algorithm.

In PTLs 1 to 3 and NPLs 1 to 2, task observation data and the like are not converted into data in a format for the estimation algorithm to accurately estimate the amount of computer resources required for task processing in the distributed processing system. Therefore, in the case of simply using the technique described in any of PTLs 1 to 3 and NPLs 1 to 2, the user may be unable to obtain the amount of computer resources estimates with estimation accuracy that should be available.

In PTLs 4 to 6, too, there is no particular mention about a data format that contributes to the prediction of the operation of the distributed processing system by the estimation algorithm.

The present invention has an object of solving the problems stated above and providing an output device, data structure, output method, and output program that provide information in a format suitable for a model that estimates the amount of computer resources required for task processing in a distributed processing system.

### Solution to Problem

An output device according to the present invention includes an output unit which outputs estimation model application information on the basis of job feature information indicating the features of the job of a distributed processing system, estimation model application information that is information in a format suitable for an estimation model that estimates the amount of computer resources required for processing a task constituting the job.

A data structure according to the present invention includes estimation model application information generated on the basis of job feature information indicating the features of the job of a distributed processing system, estimation model application information that is information in a format suitable for an estimation model that estimates the amount of computer resources required for processing a task constituting the job.

An output method according to the present invention includes outputting estimation model application information on the basis of job feature information indicating the features of the job of a distributed processing system, estimation model application information that is information in a format suitable for an estimation model that estimates the amount of computer resources required for processing a task constituting the job.

An output program according to the present invention causes a computer to execute an output process of outputting estimation model application information on the basis of job feature information indicating the features of the job of a distributed processing system, estimation model application information that is information in a format suitable for an estimation model that estimates the amount of computer resources required for processing a task constituting the job.

### Advantageous Effects of Invention

According to the present invention, it is possible to provide information in a format suitable for a model that estimates the amount of computer resources required for task processing in a distributed processing system.

### BRIEF DESCRIPTION OF DRAWINGS

FIG. 1 is a block diagram depicting an example of the structure of Exemplary Embodiment 1 of a computer resources usage estimation device according to the present invention.

FIG. 2 is an explanatory diagram depicting an example of estimation model application information output from an input data conversion unit 101.

FIG. 3 is an explanatory diagram depicting another example of estimation model application information output from the input data conversion unit 101.

FIG. 4 is a flowchart depicting an operation of a word-containing information generation process by the input data conversion unit 101 in Exemplary Embodiment 1.

FIG. 5 is an explanatory diagram depicting an example of job feature information input to the input data conversion unit 101.

FIG. 6 is an explanatory diagram depicting an example of word-containing information output from the input data conversion unit 101.

FIG. 7 is a flowchart depicting another operation of a word-containing information generation process by the input data conversion unit 101 in Exemplary Embodiment 1.

FIG. 8 is an explanatory diagram depicting another example of job feature information input to the input data conversion unit 101.

FIG. 9 is an explanatory diagram depicting another example of word-containing information output from the input data conversion unit 101.

FIG. 10 is a flowchart depicting an operation of a numerical inversion label information generation process by the input data conversion unit 101 in Exemplary Embodiment 1.

FIG. 11 is an explanatory diagram depicting another example of job feature information input to the input data conversion unit 101.

FIG. 12 is an explanatory diagram depicting an example of numerical inversion label information output from the input data conversion unit 101.

FIG. 13 is a block diagram depicting an example of the structure of Exemplary Embodiment 2 of a computer resources usage estimation device according to the present invention.

FIG. 14 is a flowchart depicting an operation of a numerical inversion label information generation process by the input data conversion unit 101 in Exemplary Embodiment 2.

FIG. 15 is an explanatory diagram depicting another example of job feature information input to the input data conversion unit 101.

FIG. 16 is an explanatory diagram depicting another example of numerical inversion label information output from the input data conversion unit 101.

FIG. 17 is a flowchart depicting an operation of an estimated memory usage reverse conversion process by an estimate reverse conversion unit 104 in Exemplary Embodiment 2.

FIG. 18 is an explanatory diagram depicting an example of numerical inversion label information output from an estimation model.

FIG. 19 is an explanatory diagram depicting an example of estimated memory usage information output from the estimate reverse conversion unit 104.

FIG. 20 is a block diagram schematically depicting an output device according to the present invention.

FIG. 21 is a block diagram schematically depicting a data structure according to the present invention.

### DESCRIPTION OF EMBODIMENT

### Exemplary Embodiment 1

[Structure]

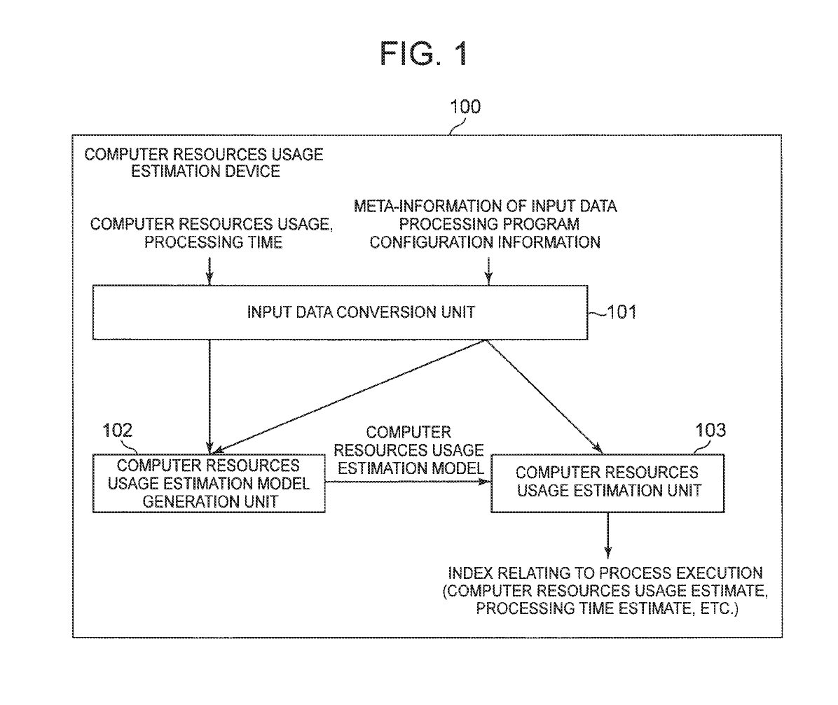

The following describes an exemplary embodiment of the present invention with reference to drawings. FIG. 1 is a block diagram depicting an example of the structure of Exemplary Embodiment 1 of a computer resources usage estimation device according to the present invention. A computer resources usage estimation device 100 depicted in FIG. 1 includes an input data conversion unit 101, a computer resources usage estimation model generation unit 102, and a computer resources usage estimation unit 103.

The computer resources usage estimation device 100 depicted in FIG. 1 is intended for a distributed processing system. The computer resources usage estimation device 100 estimates the amount of computer resources required for processing each task in the distributed processing system, using input data in a data format including word-containing information or string label information.

The input data conversion unit 101 has a function of converting job feature information included in the input data used for the generation of an estimation model into estimation model application information which is information in a format suitable for the estimation model to be generated, and outputting data including the estimation model application information.

As depicted in FIG. 1, computer resources usage and processing time are input to the input data conversion unit 101. Meta-information of input data and processing program configuration information are also input to the input data conversion unit 101.

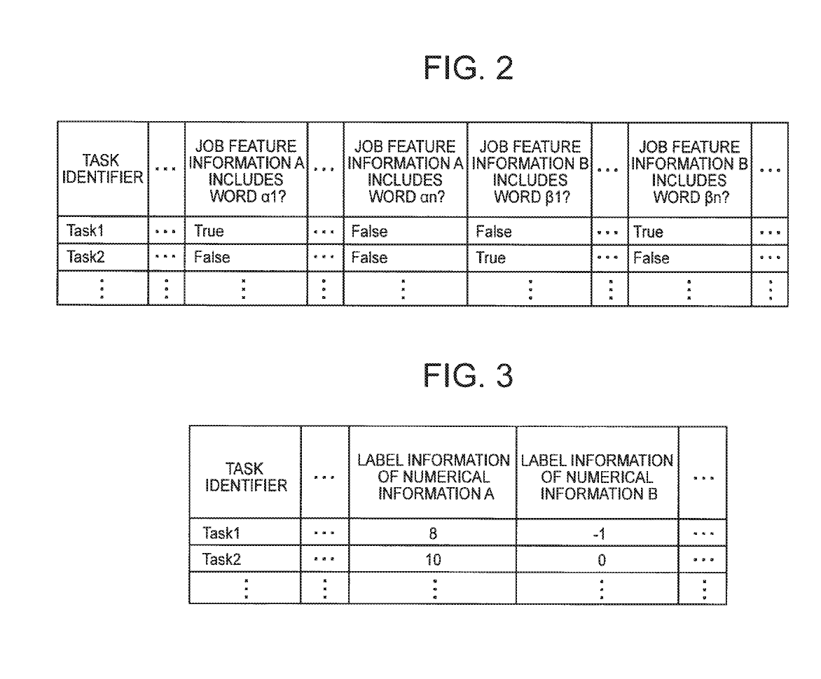

FIGS. 2 and 3 each depict an example of the estimation model application information output from the input data conversion unit 101. FIG. 2 is an explanatory diagram depicting an example of estimation model application information output from the input data conversion unit 101.

FIG. 2 depicts word-containing information included in the estimation model application information. The word-containing information depicted in FIG. 2 is made up of a task identifier and a word candidate.

The task identifier corresponds to an identification symbol of job feature information. The word candidate indicates whether or not a predetermined word is included. In FIG. 2, the word-containing information is represented by binary information for each pair of an identification symbol of job feature information and a word candidate.

For example, consider the case of indicating that a character string which is job feature information A corresponding to task identifier Task1 includes word α1. To indicate that word α1 is included, binary information True (true) is set in the word candidate “job feature information A includes word α1?” in the word-containing information of Task1. The word-containing information of Task1 indicates that job feature information A includes word α1.

Consider the case of indicating that a character string which is job feature information B corresponding to task identifier Task2 does not include word βn. To indicate that word βn is not included, binary information False (false) is set in the word candidate “job feature information B includes word βn?” in the word-containing information of Task2. The word-containing information of Task2 indicates that job feature information B does not include word βn.

FIG. 3 is an explanatory diagram depicting another example of estimation model application information output from the input data conversion unit 101. FIG. 3 depicts numerical inversion label information included in the estimation model application information. The numerical inversion label information depicted in FIG. 3 is made up of a task identifier and label information.

The task identifier corresponds to an identification symbol of numerical information. The numerical information corresponds to numerical job feature information. In FIG. 3, the numerical inversion label information is represented by character string information for each pair of an identification symbol of numerical information and label information.

For example, consider the case of indicating that the label information of numerical information A corresponding to task identifier Task1 is 8. To indicate that the label information of numerical information A is 8, character string information “8” is set in the label information “label information of numerical information A” in the numerical inversion label information of Task1. The numerical inversion label information of Task1 indicates that the label information of numerical information A is 8.

Consider the case of indicating that the label information of numerical information B corresponding to task identifier Task2 is 0. To indicate that the label information of numerical information B is 0, character string information “0” is set in the label information “label information of numerical information B” in the numerical inversion label information of Task2. The numerical inversion label information of Task2 indicates that the label information of numerical information B is 0.

The computer resources usage estimation model generation unit 102 has a function of receiving the data output from the input data conversion unit 101 and generating the estimation model. As depicted in FIG. 1, the computer resources usage estimation model generation unit 102 outputs the generated estimation model to the computer resources usage estimation unit 103.

The computer resources usage estimation unit 103 has a function of estimating the computer resources usage of a task whose feature has not been recognized yet, using the received estimation model. The computer resources usage estimation unit 103 may output an estimate of an index relating to process execution, such as processing time, other than the computer resources usage.

Although the computer resources usage estimation device 100 in this exemplary embodiment estimates computer resources usage, the computer resources usage estimation device 100 may estimate a value other than computer resources usage. For example, the computer resources usage estimation device 100 may estimate task processing time in the distributed processing system. Any value estimated by the computer resources usage estimation device 100 in this exemplary embodiment is expected to have improved estimation accuracy.

The computer resources usage estimation device 100 in this exemplary embodiment is, for example, realized by a central processing unit (CPU) that executes processes according to a program stored in a storage medium. In other words, the input data conversion unit 101, the computer resources usage estimation model generation unit 102, and the computer resources usage estimation unit 103 are, for example, realized by a CPU that executes processes according to program control.

Each unit in the computer resources usage estimation device 100 may be realized by a hardware circuit.

[Operation]

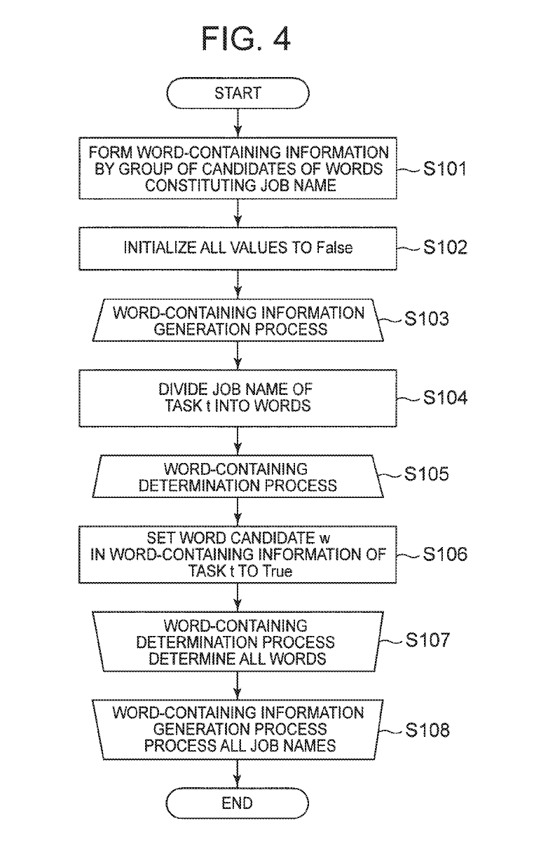

The following describes the operation of the input data conversion unit 101 in this exemplary embodiment, with reference to FIGS. 4, 7, and 10.

The operation of the input data conversion unit 101 in this exemplary embodiment generating, for a job name which is one type of job feature information, word-containing information indicating whether or not each word of a word group constituting the job name is included on the basis of the job feature information is described first, with reference to FIG. 4. FIG. 4 is a flowchart depicting an operation of the word-containing information generation process by the input data conversion unit 101 in Exemplary Embodiment 1.

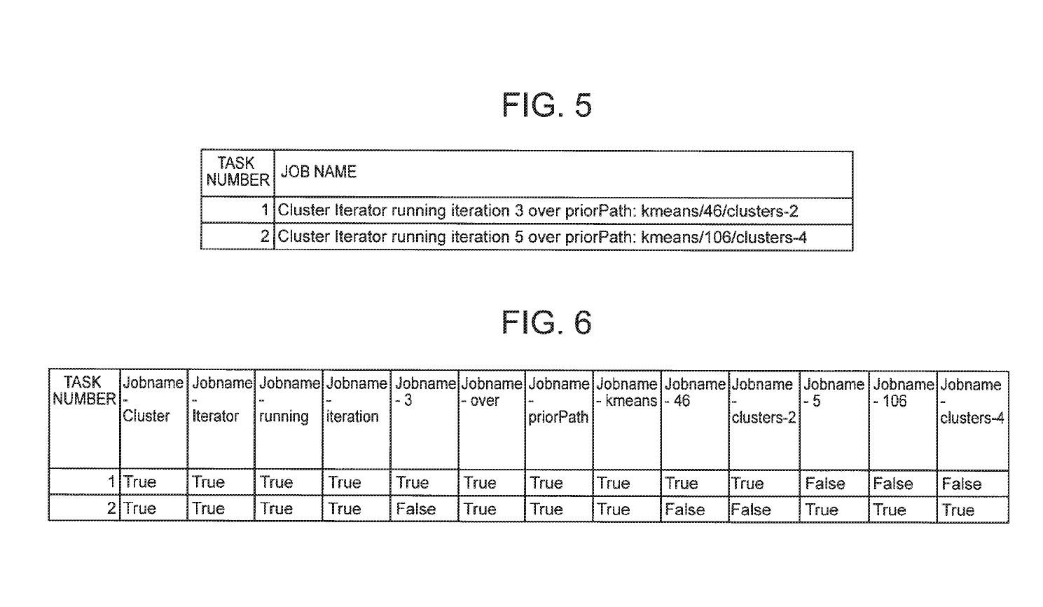

FIG. 5 is an explanatory diagram depicting an example of job feature information input to the input data conversion unit 101. FIG. 5 depicts part of task-related information which is observed in the processing in the distributed processing system. The job feature information depicted in FIG. 5 is made up of a task number and a job name.

FIG. 6 is an explanatory diagram depicting an example of word-containing information output from the input data conversion unit 101. FIG. 6 depicts the word-containing information generated by the input data conversion unit 101 on the basis of the job name included in the job feature information depicted in FIG. 5. The following describes the operation of the input data conversion unit 101 generating the word-containing information depicted in FIG. 6 on the basis of the job feature information depicted in FIG. 5, with reference to FIG. 4.

When the job feature information depicted in FIG. 5 is input, the input data conversion unit 101 forms the output word-containing information by the task number and the group of candidates of words constituting the job name included in the job feature information (step S101).

When forming the word-containing information, the input data conversion unit 101 generates each word candidate name by, for example, prefixing the identifier of the generation source information. The input data conversion unit 101 may generate each word candidate name by any other method, as long as the generated name is uniquely identifiable.

The job name with the task number “1” in the job feature information depicted in FIG. 5 is “Cluster Iterator running iteration 3 over priorPath: kmeans/46/clusters-2”. The job name with the task number “2” is “Cluster Iterator running iteration 5 over priorPath: kmeans/106/clusters-4”. Based on the input two job names, the input data conversion unit 101 forms the word-containing information by the group of candidates of words constituting each job name.

In detail, the input data conversion unit 101 prefixes “Jobname” to each of the words “Cluster”, “Iterator”, “running”, “iteration”, “3”, “over”, “priorPath”, “kmeans”, “46”, and “clusters-2” present in the job name with the task number “1”, to generate the word candidate name.

The input data conversion unit 101 also prefixes “Jobname” to each of the words “5”, “106”, and “clusters-4” not present in the job name with the task number “1” and only present in the job name with the task number “2”, to generate the word candidate name. The input data conversion unit 101 forms the word-containing information by the word candidate group indicating the generated names.

The input data conversion unit 101 generates the same number of pieces of word-containing information as the number of input pieces of job feature information. The input data conversion unit 101 sets the task number of the input job feature information as the task number of the generated word-containing information corresponding to the job feature information.

The input data conversion unit 101 then sets all word candidates in each generated piece of word-containing information to False, as an initialization process (step S102).

Following this, the input data conversion unit 101 divides the job name of the input job feature information into words (step S104). For example, the job name with the task number “1” is divided into the words “Cluster”, “Iterator”, “running”, “iteration”, “3”, “over”, “priorPath”, “kmeans”, “46”, and “clusters-2”.

The delimiter or delimiter character when the input data conversion unit 101 divides the job name into words is, for example, set by the user, the system, or the like. Alternatively, the input data conversion unit 101 may hold the delimiter or delimiter character beforehand.

The input data conversion unit 101 then sets the word candidates in the word-containing information corresponding to the divided words, to True (step S106). The binary information “True” indicates that the set word candidate is included in the job name. The input data conversion unit 101 sets True for the number of divided words (step S107).

For example, in the case of the job feature information of the task number “1”, True is set in each of the word candidates “Jobname-Cluster”, “Jobname-Iterator”, “Jobname-running”, “Jobname-iteration”, “Jobname-3”, “Jobname-over”, “Jobname-priorPath”, “Jobname-kmeans”, “Jobname-46”, and “Jobname-clusters-2” for which the corresponding words are present. Meanwhile, False remains to be set in each of the word candidates “Jobname-5”, “Jobname-106”, and “Jobname-clusters-4” for which the corresponding words are not present.

The data conversion unit 101 may set information other than True in the corresponding word candidate, as long as it is clear that the word candidate is included in the job name. For example, the input data conversion unit 101 may set the numerical value 1 in the corresponding word candidate, instead of True. In the case of setting the numerical value 1, the input data conversion unit 101 sets the numerical value 0 in each word candidate instead of False in the initialization process of step S102.

As a result of the input data conversion unit 101 setting True for the number of divided words (the determination condition in step S107 is met), the word-containing information corresponding to the input job feature information is generated. The input data conversion unit 101 repeatedly performs the process of steps S103 to S108 for the number of input pieces of job feature information.

After generating the word-containing information for the number of input pieces of job feature information (the determination condition in step S108 is met), the input data conversion unit 101 ends the generation process.

The following describes the effect of the information obtained as a result of the conversion as depicted in FIG. 6, on the amount of computer resources estimation algorithm. By referencing to the word-containing information depicted in FIG. 6, the computer resources usage estimation unit 103 can recognize the combination of words constituting the job name.

By referencing the word-containing information corresponding to the set of tasks that differ in the relationship between task feature information and the amount of computer resources, the computer resources usage estimation unit 103 can classify the tasks included in the task set depending on whether or not a predetermined word set is included.

For example, the task corresponding to each piece of task feature information depicted in FIG. 5 executes K-Means which is one of the machine learning algorithms. Even if the computer resources usage estimation unit 103 has not recognized beforehand that the task executes K-Means, the computer resources usage estimation unit 103 can recognize the tendency of the implementation of K-Means by extracting the task group corresponding to the word-containing information whose word candidate “Jobname-kmeans” is True in FIG. 6. By estimating the amount of computer resources required for task processing based on the recognition of the tendency of the implementation for each algorithm, the computer resources usage estimation unit 103 can enhance estimation accuracy.

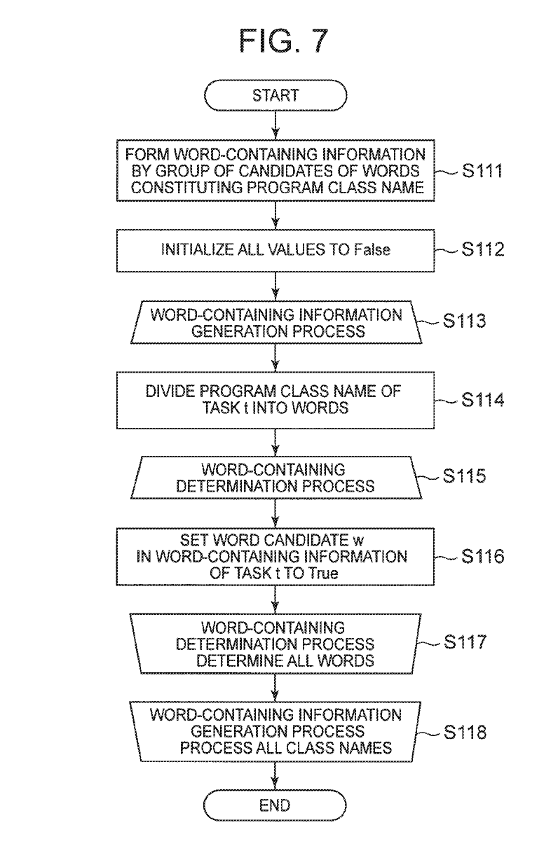

The operation of the input data conversion unit 101 in this exemplary embodiment generating, for a program class name which is one type of job feature information, word-containing information indicating whether or not each word of the word group constituting the class name is included on the basis of the job feature information is described next, with reference to FIG. 7. FIG. 7 is a flowchart depicting another operation of the word-containing information generation process by the input data conversion unit 101 in Exemplary Embodiment 1.

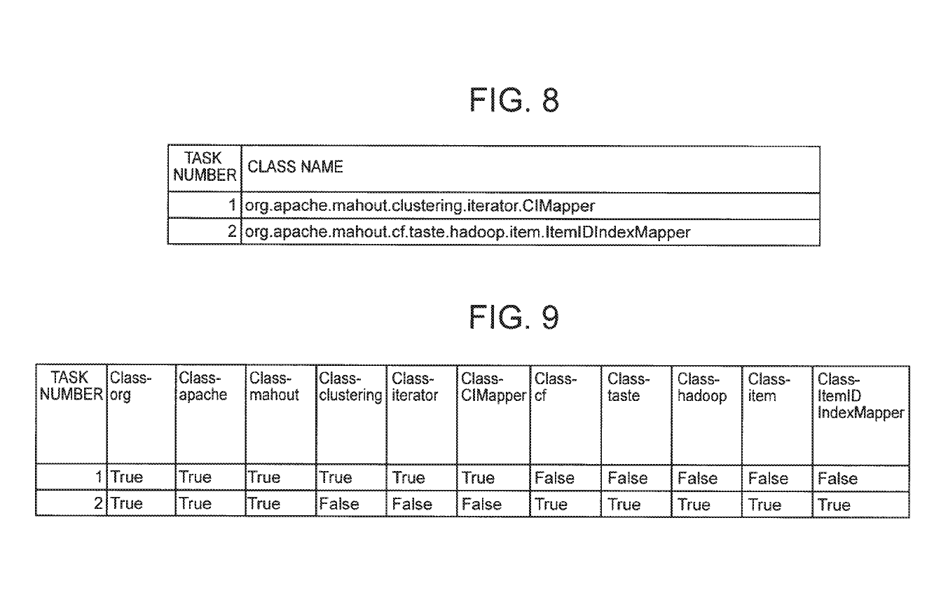

FIG. 8 is an explanatory diagram depicting another example of job feature information input to the input data conversion unit 101. FIG. 8 depicts part of task-related information which is observed in the processing in the distributed processing system. The job feature information depicted in FIG. 8 is made up of a task number and a program class name.

FIG. 9 is an explanatory diagram depicting another example of word-containing information output from the input data conversion unit 101. FIG. 9 depicts the word-containing information generated by the input data conversion unit 101 on the basis of the program class name included in the job feature information depicted in FIG. 8. The following describes the operation of the input data conversion unit 101 generating the word-containing information depicted in FIG. 9 on the basis of the job feature information depicted in FIG. 8, with reference to FIG. 7.

When the job feature information depicted in FIG. 8 is input, the input data conversion unit 101 forms the output word-containing information by the task number and the group of candidates of words constituting the program class name included in the job feature information (step S111).

When forming the word-containing information, the input data conversion unit 101 generates each word candidate name by, for example, prefixing the identifier of the generation source information. The input data conversion unit 101 may generate each word candidate name by any other method, as long as the generated name is uniquely identifiable.

The class name with the task number “1” in the job feature information depicted in FIG. 8 is “org.apache.mahout.clustering.iterator.CIMapper”. The class name with the task number “2” is “org.apache.mahout.cf.taste.hadoop.item.ItemIDIndexMapper”. Based on the input two class names, the input data conversion unit 101 forms the word-containing information by the group of candidates of words constituting each class name.

In detail, the input data conversion unit 101 prefixes “Class” to each of the words “org”, “apache”, “mahout”, “clustering”, “Aerator”, and “CIMapper” present in the class name with the task number “1”, to generate the word candidate name.

The input data conversion unit 101 also prefixes “Class” to each of the words “cf”, “taste”, “hadoop”, “item”, and “ItemIDIndexMapper” not present in the class name with the task number “1” and only present in the class name with the task number “2”, to generate the word candidate name. The input data conversion unit 101 forms the word-containing information by the word candidate group indicating the generated names.

The input data conversion unit 101 generates the same number of pieces of word-containing information as the number of input pieces of job feature information. The input data conversion unit 101 sets the task number of the input job feature information as the task number of the generated word-containing information corresponding to the job feature information.

The input data conversion unit 101 then sets all word candidates in each generated piece of word-containing information to False, as an initialization process (step S112).

Following this, the input data conversion unit 101 divides the program class name of the input job feature information into words (step S114). For example, the class name with the task number “1” is divided into the words “org”, “apache”, “mahout”, “clustering”, “iterator”, and “CIMapper”.

The delimiter or delimiter character when the input data conversion unit 101 divides the class name into words are, for example, set by the user, the system, or the like. Alternatively, the input data conversion unit 101 may hold the delimiter or delimiter character beforehand.

The input data conversion unit 101 then sets the word candidates in the word-containing information corresponding to the divided words, to True (step S116). The binary information “True” indicates that the set word candidate is included in the class name. The input data conversion unit 101 sets True for the number of divided words (step S117).

For example, in the case of the job feature information of the task number “1”, True is set in each of the word candidates “Class-org”, “Class-apache”, “Class-mahout”, “Class-clustering”, “Class-iterator”, and “Class-CIMapper” for which the corresponding words are present. Meanwhile, False remains to be set in each of the word candidates “Class-cf”, “Class-taste”, “Class-hadoop”, “Class-item”, and “Class-ItemIDIndexMapper” for which the corresponding words are not present.

The data conversion unit 101 may set information other than True in the corresponding word candidate, as long as it is clear that the word candidate is included in the program class name. For example, the input data conversion unit 101 may set the numerical value 1 in the corresponding word candidate, instead of True. In the case of setting the numerical value 1, the input data conversion unit 101 sets the numerical value 0 in each word candidate instead of False in the initialization process of step S112.

As a result of the input data conversion unit 101 setting True for the number of divided words (the determination condition in step S117 is met), the word-containing information corresponding to the input job feature information is generated. The input data conversion unit 101 repeatedly performs the process of steps S113 to S118 for the number of input pieces of job feature information.

After generating the word-containing information for the number of input pieces of job feature information (the determination condition in step S118 is met), the input data conversion unit 101 ends the generation process.

The following describes the effect of the information obtained as a result of the conversion as depicted in FIG. 9, on the amount of computer resources estimation algorithm. By referencing to the word-containing information depicted in FIG. 9, the computer resources usage estimation unit 103 can recognize the combination of words constituting the program class name.

By referencing the word-containing information corresponding to the set of tasks that differ in the relationship between task feature information and the amount of computer resources, the computer resources usage estimation unit 103 can classify the tasks included in the task set depending on whether or not a predetermined word set is included.

For example, the task corresponding to each piece of task feature information depicted in FIG. 8 executes a program implemented by Apache Mahout® which is a framework for executing a machine learning algorithm in Apache Hadoop®. Hence, True is set in the word candidate “Class-mahout” in the word-containing information corresponding to the task that executes the program implemented by Apache Mahout.

Even if the computer resources usage estimation unit 103 has not recognized beforehand that the task executes the program implemented by Apache Mahout, the computer resources usage estimation unit 103 can recognize the tendency of the implementation of Apache Mahout by extracting the task group corresponding to the word-containing information whose word candidate “Class-mahout” is True in FIG. 9. By estimating the amount of computer resources required for task processing based on the recognition of the tendency of the implementation for each algorithm, the computer resources usage estimation unit 103 can enhance estimation accuracy.

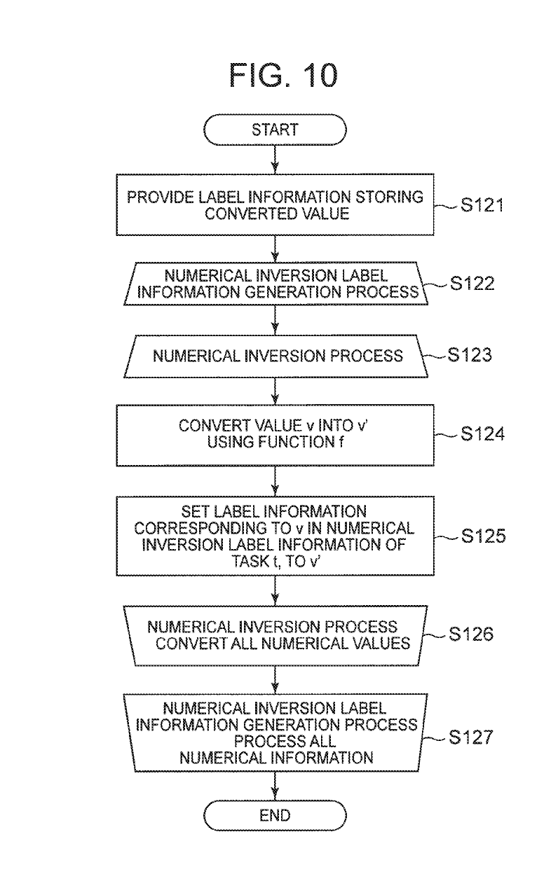

The operation of the input data conversion unit 101 in this exemplary embodiment generating numerical inversion label information on the basis of one type of job feature information that includes an observation value during program execution and an option numerical value designated during program execution is described next, with reference to FIG. 10.

FIG. 10 is a flowchart depicting an operation of the numerical inversion label information generation process by the input data conversion unit 101 in Exemplary Embodiment 1. The following describes an example where the observation value during program execution is a file read byte count and the option numerical value designated during program execution is a predetermined command line argument value.

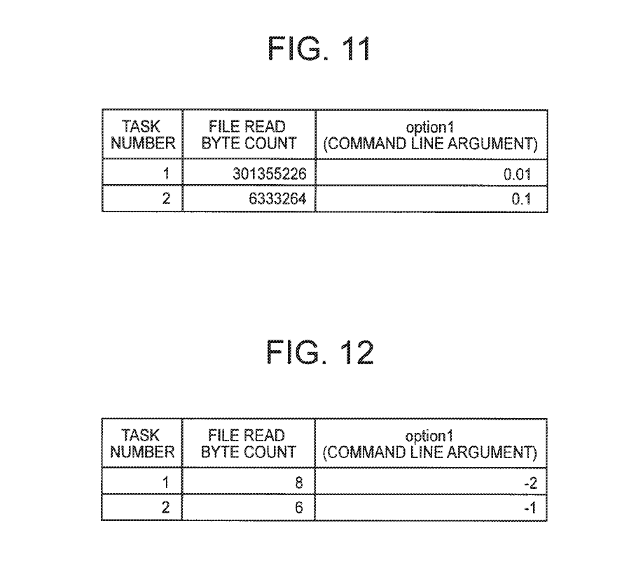

FIG. 11 is an explanatory diagram depicting another example of job feature information input to the input data conversion unit 101. FIG. 11 depicts part of task-related information which is observed in the processing in the distributed processing system. The job feature information depicted in FIG. 11 is made up of a task number, a file read byte count, and optionl which is a command line argument. Here, optionl is one of the parameters given to the algorithm executed by the task indicated by the task number.

FIG. 12 is an explanatory diagram depicting an example of numerical inversion label information output from the input data conversion unit 101. FIG. 12 depicts the numerical inversion label information generated by the input data conversion unit 101 on the basis of the values of the file read byte count and optionl included in the job feature information depicted in FIG. 11. The following describes the operation of the input data conversion unit 101 generating the numerical inversion label information depicted in FIG. 12 on the basis of the job feature information depicted in FIG. 11, with reference to FIG. 10.

When the job feature information depicted in FIG. 11 is input, the input data conversion unit 101 forms the output numerical inversion label information by the task number and a label information group (step S121). The respective values obtained by converting the values of the file read byte count and optionl included in the job feature information are set in the label information group. Each value set in label information is handled as an identifier represented by a character string.

When forming the numerical inversion label information, the input data conversion unit 101 generates each label information name by, for example, prefixing the identifier of the generation source information. The input data conversion unit 101 may generate each label information name by any other method, as long as the generated name is uniquely identifiable.

The input data conversion unit 101 may set the job feature information whose value has been replaced, as the numerical inversion label information. The numerical inversion label information depicted in FIG. 12 is generated by replacing the value in the job feature information depicted in FIG. 11. In detail, the numerical inversion label information is generated by replacing the memory usage value.

Following this, the input data conversion unit 101 converts value v included in the job feature information into value v′ using function f (step S124). Function f used when the input data conversion unit 101 converts the value is, for example, set by the user, the system, or the like. Alternatively, the input data conversion unit 101 may hold function f beforehand.

The input data conversion unit 101 uses any mathematical function for function f. Function f used for the conversion into the value depicted in FIG. 12 is f=floor(log₁₀(v)).

The input data conversion unit 101 then sets the label information of the numerical inversion label information corresponding to value v, to converted value v′ (step S125). The input data conversion unit 101 performs the value conversion and the converted value setting for the number of conversion target values included in the job feature information (step S126).

For example, in the case of the job feature information of the task number “1” depicted in FIG. 11, the file read byte count “301355226” is converted into “8” by function f. Moreover, the option1 (command line argument) “0.01” is converted into “−2” by function f.

For example, in the case of the numerical inversion label information of the task number “1” depicted in FIG. 12, the file read byte count is set to the character string “8”, and the option1 (command line argument) is set to the character string “−2”.

As a result of the input data conversion unit 101 performing the value conversion and the converted value setting for the number of conversion target values included in the job feature information (the determination condition in step S126 is met), the numerical inversion label information corresponding to the input job feature information is generated. The input data conversion unit 101 repeatedly performs the process of steps S122 to S127 for the number of input pieces of job feature information.

After generating the numerical inversion label information for the number of input pieces of job feature information (the determination condition in step S127 is met), the input data conversion unit 101 ends the generation process.

The following describes the effect of the information obtained as a result of the conversion as depicted in FIG. 12, on the amount of computer resources estimation algorithm. The numerical inversion label information depicted in FIG. 12 includes numerical information as label information of a character string.

Accordingly, in the case of using the numerical inversion label information depicted in FIG. 12, the computer resources usage estimation unit 103 can use a favorable algorithm for which numerical information is not suitable as input data and that has advantages such as highly accurate the amount of computer resources estimation or easy implementation.

For example, the naive Bayes algorithm handles input data as discrete values. When handling numerical information which is a continuous quantity, the naive Bayes algorithm interprets all values as discontinuous discrete values.

The operation of interpretation as discontinuous discrete values is not an operation that is supposed to be performed by the naive Bayes algorithm. In the case of interpreting the information as discontinuous discrete values, the naive Bayes algorithm performs overfitting or the like in the estimation process. Overfitting or the like degrades the accuracy of the amount of computer resources estimates by the naive Bayes algorithm.

The numerical inversion label information output from the input data conversion unit 101 in this exemplary embodiment includes the numerical value converted from a continuous quantity to a discrete quantity by function f, as label information. In the case where the numerical inversion label information including the label information is the input data, the computer resources usage estimation unit 103 can use an algorithm, such as the naive Bayes algorithm, that can only handle discrete values. The possibility that the computer resources usage estimation unit 103 can accurately estimate the amount of computer resources required for task processing using the naive Bayes algorithm is thus increased.

By adjusting function f, the input data conversion unit 101 can convert the distribution of the input data into another distribution. The conversion of the data distribution increases the possibility that the computer resources usage estimation unit 103 can classify data more clearly.

According to this exemplary embodiment, the amount of computer resources required for task processing in the distributed processing system are estimated accurately. By receiving the information output from the input data conversion unit 101 as input, the computer resources usage estimation model generation unit 102 can easily classify, for each estimation algorithm, the determinant of the format of function for computing the amount of computer resources. The classification of the determinant for each estimation algorithm corresponds to extracting the task group whose word candidate “Jobname-kmeans” is True or extracting the task group whose word candidate “Class-mahout” is True as mentioned above.

By receiving the classified determinant as input for generating the amount of computer resources estimation algorithm, the computer resources usage estimation model generation unit 102 can generate a function in a format close to the value distribution in task processing. The computer resources usage estimation unit 103 can enhance estimation accuracy by estimating computer resources usage using the function in a format close to the value distribution in task processing which has been generated by the computer resources usage estimation model generation unit 102.

### Exemplary Embodiment 2

[Structure]

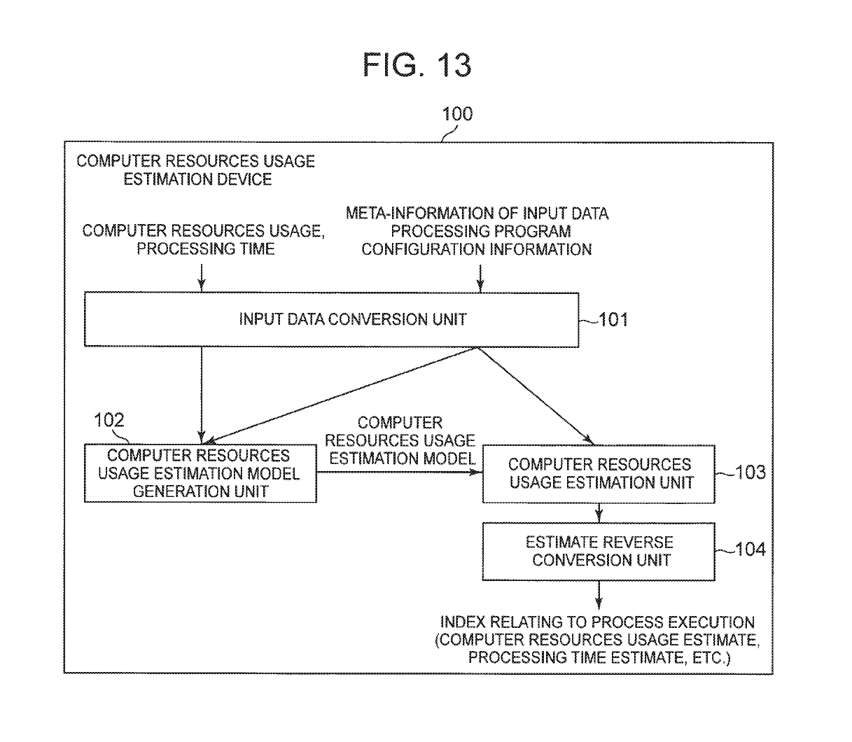

The following describes Exemplary Embodiment 2 of the present invention with reference to drawings. FIG. 13 is a block diagram depicting an example of the structure of Exemplary Embodiment 2 of a computer resources usage estimation device according to the present invention.

As depicted in FIG. 13, the computer resources usage estimation device 100 in this exemplary embodiment differs from Exemplary Embodiment 1 in that an estimate reverse conversion unit 104 is added.

The estimate reverse conversion unit 104 has a function of reversely converting the value output from the computer resources usage estimation unit 103, into a computer resources usage estimate. The estimate reverse conversion unit 104 is, for example, realized by a CPU that executes processes according to program control.

In this exemplary embodiment, the computer resources usage estimation model generation unit 102 receives the data output from the input data conversion unit 101, and generates the estimation model. The computer resources usage estimation unit 103 receives the data output from the input data conversion unit 101, and outputs, in the same format as the received data, the value of computer resources usage of a task whose feature has not been recognized yet.

The estimate reverse conversion unit 104 converts the value indicating the computer resources usage estimate output from the computer resources usage estimation unit 103 into numerical information indicating the computer resources usage estimate, and outputs the numerical information. The use of the computer resources usage estimation device 100 in this exemplary embodiment enables the user, the distributed processing system scheduler, etc. to estimate the amount of computer resources required for task processing.

[Operation]

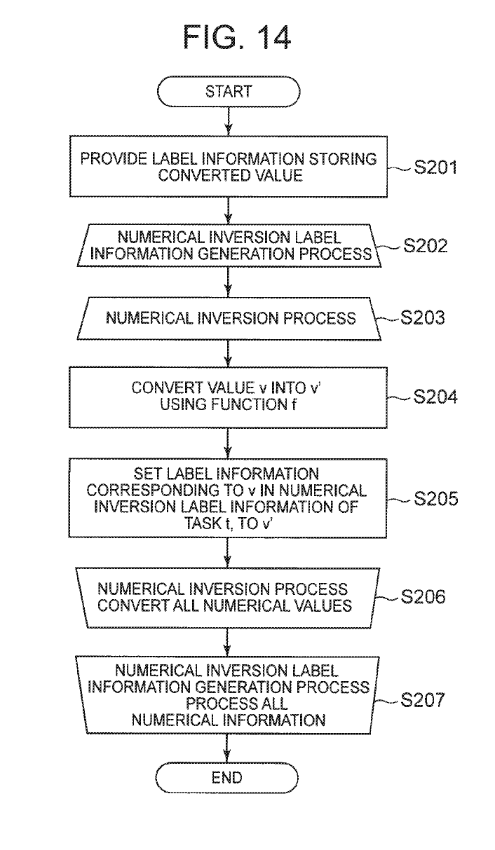

The following describes the operation of the input data conversion unit 101 and the operation of the estimate reverse conversion unit 104 in this exemplary embodiment, with reference to FIGS. 14 and 17 respectively.

The operation of the input data conversion unit 101 in this exemplary embodiment generating numerical inversion label information on the basis of one type of job feature information that includes computer resources usage observed during program execution is described first, with reference to FIG. 14. FIG. 14 is a flowchart depicting an operation of the numerical inversion label information generation process by the input data conversion unit 101 in Exemplary Embodiment 2.

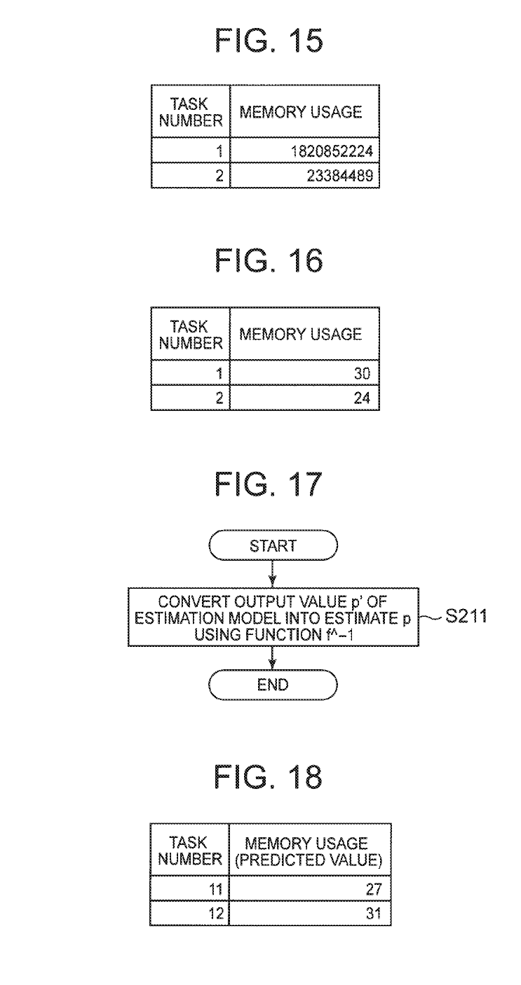

FIG. 15 is an explanatory diagram depicting another example of job feature information input to the input data conversion unit 101. FIG. 15 depicts part of task-related information which is observed in the processing in the distributed processing system. The job feature information depicted in FIG. 15 is made up of a task number and memory usage. In this exemplary embodiment, memory usage is the amount of computer resources to be estimated.

FIG. 16 is an explanatory diagram depicting another example of numerical inversion label information output from the input data conversion unit 101. FIG. 16 depicts the numerical inversion label information generated by the input data conversion unit 101 on the basis of the memory usage included in the job feature information depicted in FIG. 15. The following describes the operation of the input data conversion unit 101 generating the numerical inversion label information depicted in FIG. 16 on the basis of the job feature information depicted in FIG. 15, with reference to FIG. 14.

When the job feature information depicted in FIG. 15 is input, the input data conversion unit 101 forms the output numerical inversion label information by the task number and a label information group (step S201). The value obtained by converting the memory usage included in the job feature information is set in the label information group. Each value set in label information is handled as an identifier represented by a character string.

When forming the numerical inversion label information, the input data conversion unit 101 generates each label information name by, for example, prefixing the identifier of the generation source information. The input data conversion unit 101 may generate each label information name by any other method, as long as the generated name is uniquely identifiable.

The input data conversion unit 101 may set the job feature information whose value has been replaced, as the numerical inversion label information. The numerical inversion label information depicted in FIG. 16 is generated by replacing the value in the job feature information depicted in FIG. 15. In detail, the numerical inversion label information is generated by replacing the memory usage value.

Following this, the input data conversion unit 101 converts value v included in the job feature information into value v′ using function f (step S204). Function f used when the input data conversion unit 101 converts the value is, for example, set by the user, the system, or the like. Alternatively, the input data conversion unit 101 may hold function f beforehand.

The input data conversion unit 101 uses any mathematical function for function f. Function f used for the conversion into the value depicted in FIG. 16 is f=floor(log₂(v)).

The input data conversion unit 101 then sets the label information of the numerical inversion label information corresponding to value v, to converted value v′ (step S205). The input data conversion unit 101 performs the value conversion and the converted value setting for the number of conversion target values included in the job feature information (step S206).

For example, in the case of the job feature information of the task number “1” depicted in FIG. 15, the memory usage “1820852224” is converted into “30” by function f. In the case of the numerical inversion label information of the task number “1” depicted in FIG. 16, the memory usage is set to the character string “30”.

As a result of the input data conversion unit 101 performing the value conversion and the converted value setting for the number of conversion target values included in the job feature information (the determination condition in step S206 is met), the numerical inversion label information corresponding to the input job feature information is generated. The input data conversion unit 101 repeatedly performs the process of steps S202 to S207 for the number of input pieces of job feature information.

After generating the numerical inversion label information for the number of input pieces of job feature information (the determination condition in step S207 is met), the input data conversion unit 101 ends the generation process.

The input data conversion unit 101 outputs the generated numerical inversion label information to the computer resources usage estimation model generation unit 102 including the machine learning algorithm and the like. The computer resources usage estimation model generation unit 102 generates an estimation model for computing a memory usage estimate, using the received numerical inversion label information.

The operation of the estimate reverse conversion unit 104 in this exemplary embodiment reversely converting the output value of the estimation algorithm into estimated computer resources usage is described next, with reference to FIG. 17. FIG. 17 is a flowchart depicting an operation of the estimated memory usage reverse conversion process by the estimate reverse conversion unit 104 in Exemplary Embodiment 2. FIG. 17 depicts the operation of the estimate reverse conversion unit 104 reversely converting the output value of the estimation model into a memory usage estimate.

FIG. 18 is an explanatory diagram depicting an example of numerical inversion label information output from the estimation model. The numerical inversion label information is made up of a task number and memory usage (predicted value). The value set in the memory usage (predicted value) is the estimated memory usage after the conversion by function f.

As depicted in FIG. 18, the memory usage (predicted value) of the numerical inversion label information of the task number “11” is “27”. In other words, the output value of the estimation model for the task of the task number “11” is “27”. The memory usage (predicted value) of the numerical inversion label information of the task number “12” is “31”. In other words, the output value of the estimation model for the task of the task number “12” is “31”.

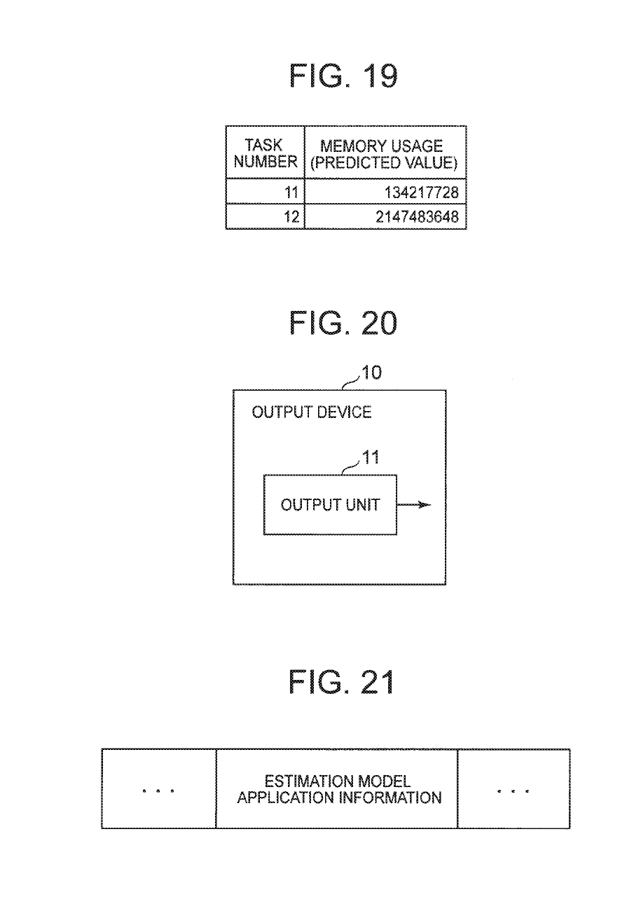

FIG. 19 is an explanatory diagram depicting an example of estimated memory usage information output from the estimate reverse conversion unit 104. FIG. 19 depicts the estimated memory usage information generated by the estimate reverse conversion unit 104 reversely converting the memory usage estimate included in the numerical inversion label information output from the estimation model depicted in FIG. 18. The estimated memory usage information is made up of a task number and memory usage (predicted value). The unit of memory usage (predicted value) is bytes.

As depicted in FIG. 19, the memory usage (predicted value) of the estimated memory usage information of the task number “11” is “134217728”. In other words, the memory usage estimate for the task of the task number “11” is 134217728 bytes. The memory usage (predicted value) of the estimated memory usage information of the task number “12” is “2147483648”. In other words, the memory usage estimate for the task of the task number “12” is 2147483648 bytes.

The following describes the operation of the estimate reverse conversion unit 104 generating the estimated memory usage information depicted in FIG. 19 on the basis of the numerical inversion label information depicted in FIG. 18, with reference to FIG. 17.

The estimate reverse conversion unit 104 feeds output value p′ included in the numerical inversion label information output from the estimation model, to inverse function f ⁻¹ of function f used in the conversion target value conversion process in step S204 in FIG. 14. In this exemplary embodiment, f⁻¹ is f⁻¹=2^{p′}. As a result of feeding f⁻¹, the estimate reverse conversion unit 104 obtains estimate p (step S211). The estimate reverse conversion unit 104 generates estimated memory usage information on the basis of the obtained estimate p.

The estimate reverse conversion unit 104 repeatedly performs the process of step S211 for the number of input pieces of numerical inversion label information. After generating estimated memory usage information for the number of input pieces of numerical inversion label information, the estimate reverse conversion unit 104 ends the process.

Thus, the computer resources usage estimation device 100 in this exemplary embodiment can convert the character string included in the numerical inversion label information output from the estimation model, into a computer resources usage estimate which is numerical information. By using the converted estimate, the distributed processing system can process the task faster or more efficiently. The use of the estimate increases the possibility that the amount of computer resources assigned to the process can be made to minimum required quantity.

For example, suppose the user sets to use 2 GB memory for all processes in the distributed processing system. With this setting, a computer with 4 GB memory can execute two processes in parallel. In the case where the memory used for a process is 1 GB, however, the setting means that 2 GB memory is unnecessarily assigned to the computer.

If it is possible to estimate that the memory required for the process is 1 GB, the user can perform setting so that the distributed processing system assigns four processes all at once to a computer with 4 GB memory. By executing the four processes in parallel, the distributed processing system can process the job at double speed, as compared with the aforementioned setting. Moreover, the unnecessarily assignment of 2 GB memory is avoided, which contributes to higher computer resources use efficiency than the aforementioned setting.

The following describes the effect of the information obtained as a result of the conversion as depicted in FIG. 16, on the amount of computer resources estimation algorithm.

The numerical inversion label information depicted in FIG. 16 includes estimation target numerical information as label information of a character string.

Accordingly, in the case of using the numerical inversion label information depicted in FIG. 16, the computer resources usage estimation unit 103 can use a favorable algorithm with which numerical information is hard to be estimated as an estimate and that has advantages such as highly accurate the amount of computer resources estimation or easy implementation.

For example, the naive Bayes algorithm handles discrete values as an estimation target. When handling numerical information which is a continuous quantity as an estimation target, the naive Bayes algorithm interprets all values as discontinuous discrete values.

The operation of interpretation as discontinuous discrete values is not an operation that is supposed to be performed by the naive Bayes algorithm. In the case of interpreting the information as discontinuous discrete values, the naive Bayes algorithm performs overfitting or the like in the estimation process. Overfitting or the like degrades the accuracy of the estimate of the amount of computer resources by the naive Bayes algorithm.

The numerical inversion label information output from the input data conversion unit 101 in this exemplary embodiment includes the numerical value converted from a continuous quantity to a discrete quantity by function f, as the label information. In the case where the numerical inversion label information including the label information is an estimation target, the computer resources usage estimation unit 103 can use an algorithm, such as the naive Bayes algorithm, that can only handle discrete values as estimates. The possibility that the computer resources usage estimation unit 103 can accurately estimate the amount of computer resources required for task processing using the naive Bayes algorithm is thus increased.

By adjusting function f, the computer resources usage estimation device 100 can obtain an estimate of appropriate resolution. For example, the computer resources usage estimation device 100 can estimate a large estimate without being affected by a slight change, by using a logarithmic function as function f. This increases the possibility that the amount of computer resources is estimated to an appropriate degree in conformity with the status of the distributed processing system.

The following describes an overview of the present invention. FIG. 20 is a block diagram schematically depicting an output device according to the present invention. An output device 10 according to the present invention is provided with an output unit 11 (for example, the input data conversion unit 101) for outputting, on the basis of job feature information indicating the features of the job of a distributed processing system, estimation model application information that is information in a format suitable for an estimation model that estimates the amount of computer resources required for processing a task constituting the job.

With such a structure, the output device can provide information in a format suitable for a model that estimates the amount of computer resources required for task processing in a distributed processing system.

The estimation model application information may include word-containing information having binary information that indicates whether or not a character string indicated by the character string information included in the job feature information includes a prescribed word.

With such a structure, the output device can provide information indicating whether or not a job name or a class name includes a prescribed word.

The estimation model application information may include numerical inversion label information having, as string label information, a value derived by converting, by a prescribed function, the numeric value indicated by the numerical information included in the job feature information.

With such a structure, the output device can provide information including string label information that can be easily handled by the estimation model.

The output device 10 may include a form conversion unit (for example, the estimate reverse conversion unit 104) for outputting the estimation model application information output from the estimation model, in a same format as the job feature information corresponding to the estimation model application information.

With such a structure, the output device can provide information of computer resources usage in a format desired by the user.

The output device 10 may include a computer resources estimation unit (for example, the computer resources usage estimation unit 103) for estimating the amount of computer resources required for processing the task included in the job corresponding to the job feature information in the distributed processing system, by feeding the estimation model application information output from the output unit 11 on the basis of the job feature information into the estimation model.

With such a structure, the output device can estimate computer resources usage on the basis of estimation model application information.

The output device 10 may include a computer resources estimation model generation unit (for example, the computer resources usage estimation model generation unit 102) for generating the estimation model for estimating the amount of computer resources required for processing the task included in the job corresponding to the job feature information in the distributed processing system, using the estimation model application information output from the output unit 11 on the basis of the job feature information.

With such a structure, the output device can generate a computer resources usage estimation model on the basis of estimation model application information.

FIG. 21 is a block diagram schematically depicting a data structure according to the present invention. The data structure according to the present invention includes estimation model application information generated on the basis of job feature information indicating the features of the job of a distributed processing system, estimation model application information that is information in a format suitable for an estimation model that estimates the amount of computer resources required for processing a task constituting the job.

With such a structure, the data structure can provide information in a format suitable for a model that estimates the amount of computer resources required for task processing in a distributed processing system.

The estimation model application information may include word-containing information having binary information that indicates whether or not a character string indicated by the character string information included in the job feature information includes a prescribed word.

With such a structure, the data structure can provide information indicating whether or not a job name or a class name include a prescribed word.

The estimation model application information may include numerical inversion label information having, as string label information, a value derived by converting, by a prescribed function, the numeric value indicated by the numerical information included in the job feature information.

With such a structure, the data structure can provide information including string label information that can be easily handled by the estimation model.

Although the present invention has been described with reference to the above exemplary embodiments and examples, the present invention is not limited to the above exemplary embodiments and examples. Various changes understandable by those skilled in the art can be made to the structures and details of the present invention within the scope of the present invention.

This application claims priority based on Japanese Patent Application No. 2015-010492 filed on Jan. 22, 2015, the disclosure of which is incorporated herein in its entirety.

### REFERENCE SIGNS LIST

10 output device

11 output unit

100 computer resources usage estimation device

101 input data conversion unit

102 computer resources usage estimation model generation unit

103 computer resources usage estimation unit

104 estimate reverse conversion unit

1. An output device comprising
an output unit which outputs estimation model application information on the basis of job feature information indicating the features of the job of a distributed processing system, estimation model application information that is information in a format suitable for an estimation model that estimates the amount of computer resources required for processing a task constituting the job.

2. The output device according to claim 1, wherein the estimation model application information includes word-containing information having binary information that indicates whether or not a character string indicated by the character string information included in the job feature information includes a prescribed word.

3. The output device according to claim 1, wherein the estimation model application information includes numerical inversion label information having, as string label information, a value derived by converting, by a prescribed function, the numeric value indicated by the numerical information included in the job feature information.

4. The output device according to claim 1, comprising
a form conversion unit which outputs the estimation model application information output from the estimation model, in a same format as the job feature information corresponding to the estimation model application information.

5. The output device according to claim 1, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.

6.-8. (canceled)

9. An output method comprising
outputting estimation model application information on the basis of job feature information indicating the features of the job of a distributed processing system, estimation model application information that is information in a format suitable for an estimation model that estimates the amount of computer resources required for processing a task constituting the job.

10. A non-transitory computer-readable recording medium having recorded therein an output program for causing a computer to execute
an output process of outputting estimation model application information on the basis of job feature information indicating the features of the job of a distributed processing system, estimation model application information that is information in a format suitable for an estimation model that estimates the amount of computer resources required for processing a task constituting the job.

11. The output device according to claim 2, wherein the estimation model application information includes numerical inversion label information having, as string label information, a value derived by converting, by a prescribed function, the numeric value indicated by the numerical information included in the job feature information.

12. The output device according to claim 2, comprising
a form conversion unit which outputs the estimation model application information output from the estimation model, in a same format as the job feature information corresponding to the estimation model application information.

13. The output device according to claim 3, comprising
a form conversion unit which outputs the estimation model application information output from the estimation model, in a same format as the job feature information corresponding to the estimation model application information.

14. The output device according to claim 11, comprising
a form conversion unit which outputs the estimation model application information output from the estimation model, in a same format as the job feature information corresponding to the estimation model application information.

15. The output device according to claim 2, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.

16. The output device according to claim 3, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.

17. The output device according to claim 4, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.

18. The output device according to claim 11, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.

19. The output device according to claim 12, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.

20. The output device according to claim 13, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.

21. The output device according to claim 14, comprising
a computer resources estimation unit which estimates the amount of computer resources required for processing the task included in the job corresponding to the job feature information in the distributed processing system, by feeding the estimation model application information output from the output unit on the basis of the job feature information into the estimation model.
